(19) United States
(12) Patent Application Publication
(10) Pub. No.: US 2015/0367365 A1
(43) Pub. Date: Dec. 24, 2015

(54) Solar Powered Portable Mister

(71) Applicant: Darion Burks, Cleveland, OH (US)

(72) Inventor: Darion Burks, Cleveland, OH (US)

(21) Appl. No.: 14/744,760

(22) Filed: Jun. 19, 2015

Related U.S. Application Data
(60) Provisional application No. 62/015,138, filed on Jun. 20, 2014.

(51) Int. Cl. B05B 9/04; B05B 9/08

(52) U.S. Cl. CPC B05B 9/0426; B05B 9/0888

(57) ABSTRACT

A solar powered portable mister includes at least one storage tank, a spray wand unit, a photovoltaics module, a battery, and a pump system. The at least one storage tank is utilized to store sunscreen so that the sunscreen can be efficiently and quickly sprayed to a large number of people through the spray wand unit. The pump system dispenses the sunscreen from the at least one storage tank and into the spray wand unit through a connector tube, where the pump system is powered from the battery and a power switch that is operated by the user. The photovoltaics module constantly recharges the battery during the operation of the solar powered portable mister as it increases the operational time of the solar powered portable mister.

The current application claims a priority to the U.S. Provisional Patent application Ser. No. 62/015,138 filed on Jun. 20, 2014.

### FIELD OF THE INVENTION

The present invention relates generally to sunscreen as well as misters, sprayers, and similar apparatuses for dispensing and delivering liquid. More specifically, the present invention is a solar powered misting device that is worn on a user's back for the purpose of spraying misted sunscreen solution stored within the device. The present invention allows a single operator to apply sunscreen to a large amount of people in a short amount of time.

### BACKGROUND OF THE INVENTION

Prolonged exposure to sunlight in the outdoors results in a multitude of problems due to excessive ultraviolet (UV) radiation. The danger of UV radiation is often underestimated, particularly on cloudy days. Harmful UVA (long wave) and UVB (shortwave) rays can result in conditions such as solar lentigo (sunspots), leathery skin, and wrinkles as well as more serious conditions such as sunburn and skin cancer. Sun damage to the skin is often irreversible and over time becomes much more apparent and visible. Sunscreen is the most common means of reflecting the sun's harmful UV radiation to prevent sunburn as well as reduce the likelihood of skin cancer. Sunscreen is also able to slow the development of wrinkled skin if properly and consistently used. Unfortunately, despite these benefits, many people forget to apply or bring sunscreen when spending extended periods of time outdoors. This is problematic as neglectful people are left exposed to harmful UV radiation. Oftentimes in a large venue, people must forfeit their seats or spaces in line and leave the venue to purchase sunscreen from a vendor. The present invention seeks to address the aforementioned issues as well as enhance and improve upon currently existing solutions.

The present invention is a solar powered portable mister for storing and delivering sunscreen solution stored within the device. More specifically, the sunscreen is stored within a liquid storage compartment of the present invention so that the stored sunscreen can be dispensed through an electrical pump and a spray wand of the present invention as fine mist. The electrical pump is controlled through the spray wand and powered through a battery that is recharged with mounted solar panels. The battery can also be recharged with a dedicated charging dock that may be connected to an external power source such as an electrical power outlet. Once the sunscreen is dispensed through the present invention, a single operator who wears the present invention as a backpack is able to quickly and conveniently apply sunscreen to a large number of people who require sunscreen.

### BRIEF DESCRIPTION OF THE DRAWINGS

FIG. 1 is a perspective view of the present invention.

FIG. 2 is a front view of the present invention without showing the spray wand unit and the connector tube, showing the plane upon which a cross section view is taken shown in FIG. 3

FIG. 3 is a cross section view of the present invention without showing the spray wand unit and the connector tube taken along line A-A of FIG. 2.

FIG. 4 is a perspective view of the pump system of the present invention.

FIG. 5 is a perspective view of the battery system of the present invention.

FIG. 6 is a perspective view of the photovoltaics module of the present invention.

FIG. 7 is a front perspective view of the spray tank enclosure of the present invention.

FIG. 8 is a rear perspective view of the spray tank enclosure of the present invention.

FIG. 9 is a side view of the spray tank enclosure of the present invention.

FIG. 10 is a perspective view of the spray wand unit of the present invention.

### DETAIL DESCRIPTIONS OF THE INVENTION

All illustrations of the drawings are for the purpose of describing selected versions of the present invention and are not intended to limit the scope of the present invention.

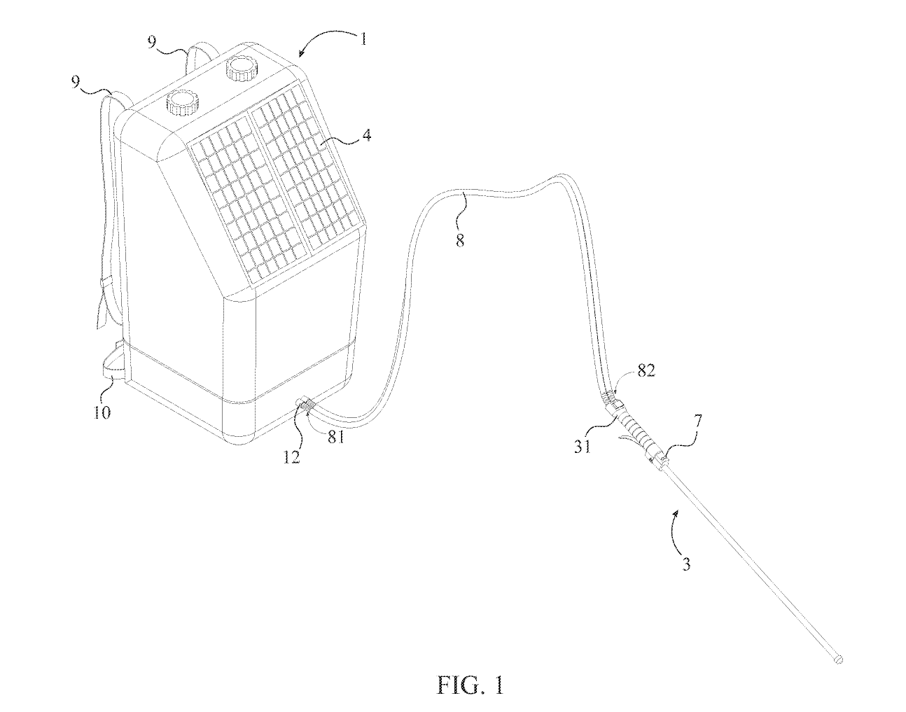

The present invention is a solar powered portable mister that is utilized to spray sunscreen. More specifically, the present invention provides a convenient and affordable solution so that people can be misted with sunscreen solution, without having to leave their activity or having to purchase full sized bottles of sunscreen. The present invention is also particularly useful in large venues in which people are exposed to the sunlight and UV radiation for prolonged periods of time such as sporting events, concerts, and amusement parks. The solar powered portable mister comprises a spray tank enclosure 1, at least one storage tank 2, a spray wand unit 3, a photovoltaics (PV) module 4, a battery 5, a pump system 6, a power switch 7, a connector tube 8, a pair of adjustable shoulder straps 9, and an adjustable waist strap 10. In reference to FIG. 1 that shows the general configuration, the PV module 4 is externally mounted onto the spray tank enclosure 1 while the at least one storage tank 2, the battery 5, and the pump system 6 are internally positioned within the spray tank enclosure 1. The spray tank enclosure 1 is in fluid communication with the spray wand unit 3 through the connector tube 8 so that the stored sunscreen within the at least one storage tank 2 can be dispensed out of the present invention. The PV module 4, the battery 5, and the pump system 6 are electrically connected to each other by the power switch 7. As a result, the power switch 7 allows the operator of the present invention control the dispensing process of the sunscreen.

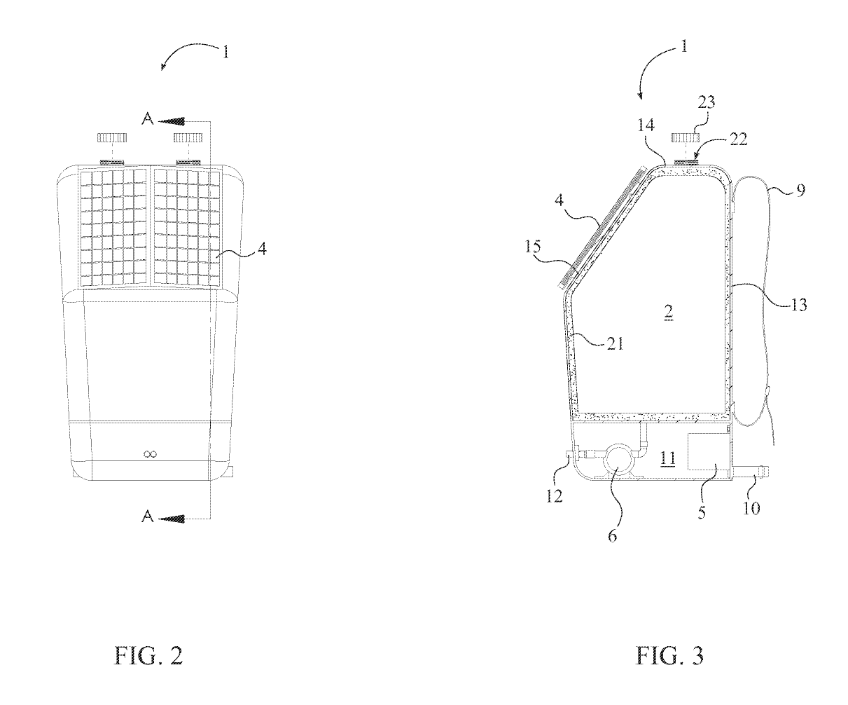

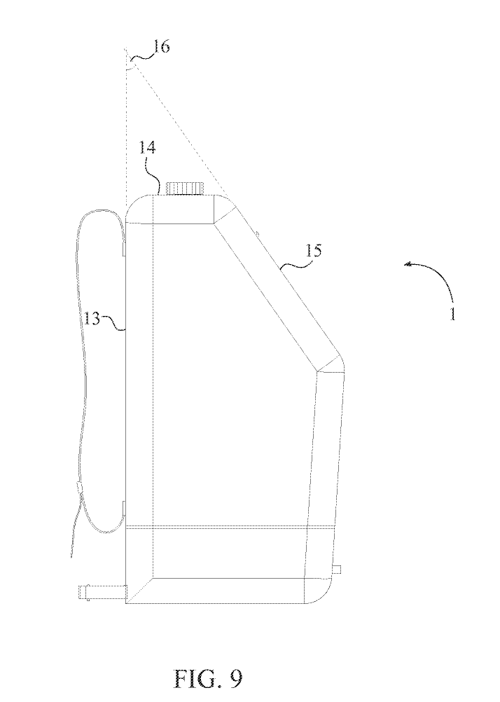

The spray tank enclosure 1 is the main body of the present invention as all of the other components of the present invention are either attached or connected to the spray tank enclosure 1. Additionally, the spray tank enclosure 1 also determines the overall shape of the present invention. In reference to FIG. 2-3, the spray tank enclosure 1 comprises an accessory compartment 11, an outlet 12, a backing 13, a top surface 14, and an angled-front surface 15. In the preferred embodiment of the present invention, the backing 13 is preferably shaped into a flat surface so that the backing 13 is able to rest against the back of the operator when the spray tank enclosure 1 is worn as a backpack. The backing 13 is adjacently positioned with the top surface 14 and a bottom surface of the spray tank enclosure 1 at a right angle. The angled-front surface 15 is adjacently positioned with the top surface 14 and positioned opposite of the backing 13. In reference to FIG. 9, the angled-front surface 15 and the backing 13 create an acute angle 16 within the spray tank enclosure 1 as the angle placement of the angled-front surface 15 optimizes the output of the PV module 4. The accessory compartment 11 that houses the battery 5 and the pump system 6 is positioned within the spray tank enclosure 1, adjacent to the bottom surface.

The at least one storage tank 2 functions as a storing container for the sunscreen so that the present invention is always able to dispense sunscreen upon the discretion of the operator. The at least one storage tank 2 is integrated into the spray tank enclosure 1 in such a way that the at least one storage tank 2 is positioned adjacent to the accessory compartment 11. In other words, the at least one storage tank 2 is vertically positioned atop the accessory compartment 11 so that the at least one storage tank 2 is able to store sunscreen within and dispense the stored sunscreen according to system parameters. In reference to FIG. 3, the at least one storage tank 2 is superimposed by an insulation layer 21 in order to maintain the sunscreen in a lower temperature compare to the atmospheric temperature and comprises a tank opening 22 and a cap 23. The tank opening 22 allows the operator to fill up the at least one storage tank 2 with the sunscreen as the tank opening 22 traverses through the spray tank enclosure 1 and provides an access opening for the at least one storage tank 2. The cap 23 is concentrically engaged with the tank opening 22 so that the tank opening 22 can be closed with the cap 23. The at least one storage tank 2 of the preferred embodiment includes a first storage tank and a second storage tank, wherein each tank is independent from one another. For example, each storage tank can serve as a receptacle for a different type of solution as the first storage tank and second storage tank may respectively store sunscreen and aloe vera solution for both protection from UV radiation and relief for sunburns. However, the present invention is not limited with respect to the size and capacity of the liquid storage tank and number of storage tanks integrated into the spray tank enclosure 1.

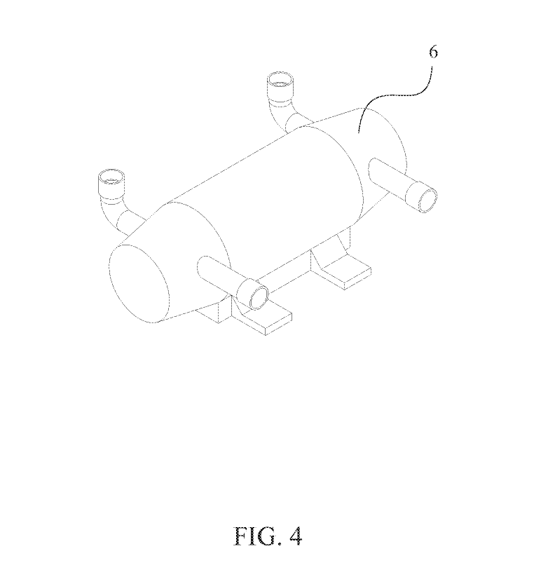

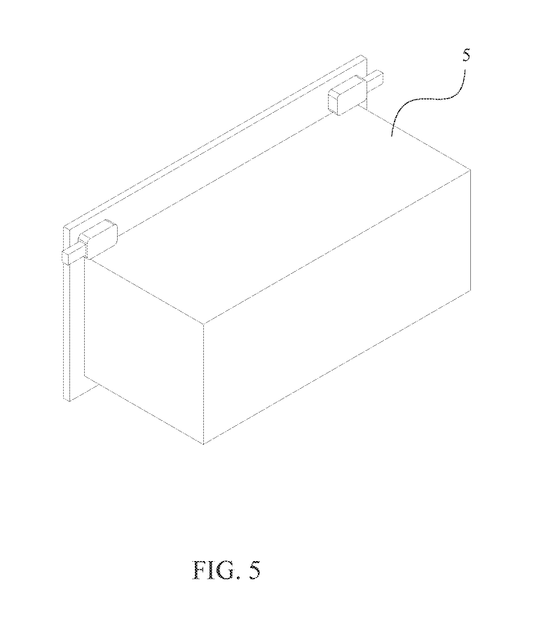

In reference to FIG. 3-5, the pump system 6 is mounted within the accessory compartment 11 while the battery 5 is removably attached with the accessory compartment 11. The outlet 12 traverses through the accessory compartment 11, adjacent to the pump system 6, so that the outlet 12 can be in fluid communication with the at least one storage tank 2 through the pump system 6. Since the battery 5 can be removed from the spray tank enclosure 1, the battery 5 is able to close the opening of the accessory compartment 11 that is positioned adjacent to the backing 13. The opening also allows the pump system 6 and other internal components that provide fluid communication with the outlet 12 and the at least one storage tank 2 to be accessed when necessary. The pump system 6 is able to dispense the sunscreen from the at least one storage tank 2 and into the spray wand unit 3 through the outlet 12. In the preferred embodiment of the present invention, the battery 5 can be recharged in two primary configurations. Since the battery 5 can be disconnected and removed from the accessory compartment 11, the operator can electrically connect the battery 5 into a dedicated charging dock that is then connected to an external power source such as an electrical power outlet 12. Alternatively, the battery 5 may be charged through the PV module 4 and direct sunlight while the present invention is in use. This allows the operator to continuously operate the present invention as the battery 5 recharges simultaneously.

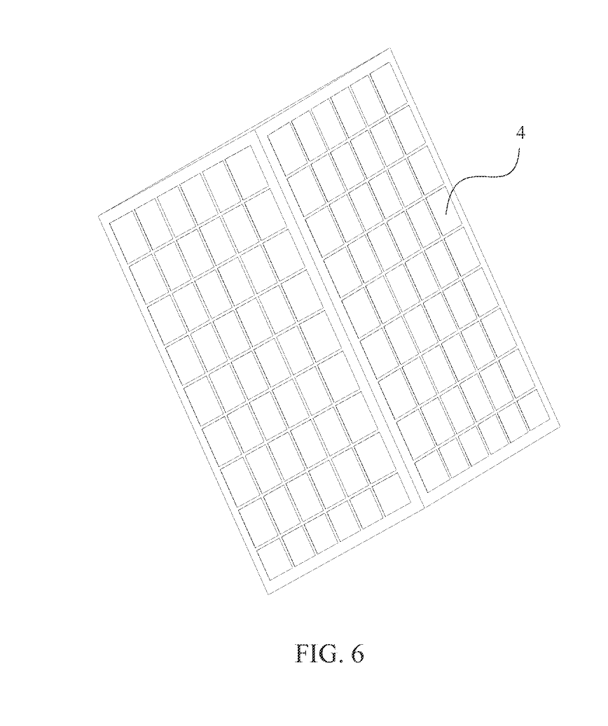

In reference to FIG. 6, the PV module 4, which continuously recharges the battery 5, is adjacently positioned with the angled-front surface 15 so that the PV module 4 is able to receive the maximum sunlight exposure. Since the PV module 4 is electrically connected with the battery 5, the PV module 4 is able to recharge the battery 5 by utilizing the sunlight during daytime. Then the battery 5 is able to power the pump system 6 with the activation of the power switch 7 so that the sunscreen can be dispensed from the at least one storage tank 2.

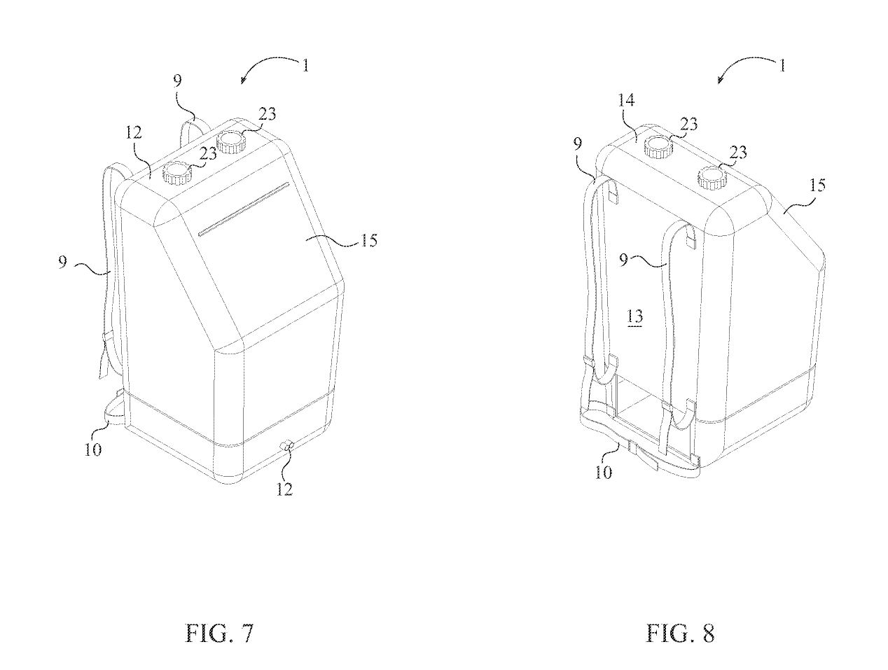

The spray tank enclosure 1 is secured to the operator's body by two different attachment methods which are the pair of adjustable shoulder straps 9 and the adjustable waist strap 10. The pair of adjustable shoulder straps 9 is utilized to secure the spray tank enclosure 1 around the shoulders of the operator while the adjustable waist strap 10 is utilized to secure the spray tank enclosure 1 around the waist of the operator. In reference to FIG. 7-8, the pair of adjustable shoulder straps 9 is vertically extended along the spray tank enclosure 1 and positioned adjacent to the at least one storage tank 2 in such a way that the pair of adjustable shoulder straps 9 is externally connected to the backing 13. The adjustable waist strap 10 is horizontally extended across the spray tank enclosure 1 and positioned adjacent to the accessory compartment 11. Similar to the pair of adjustable shoulder straps 9, the adjustable waist strap 10 is also externally connected to the backing 13.

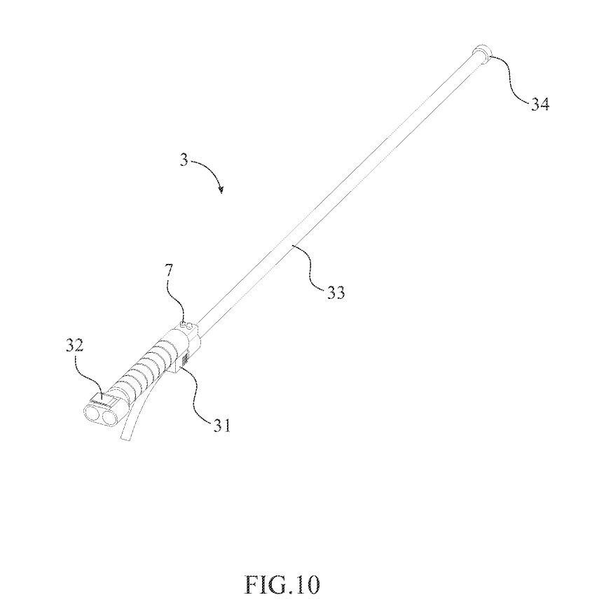

The spray wand unit 3 that is in fluid communication with the outlet 12 through the connector tube 8 and dispenses the sunscreen while allowing the operator to control the dispensing process. In reference to FIG. 10, the spray wand unit 3 comprises a spray gun 31, a belt attachment 32, a wand extension 33, and a nozzle 34. The belt attachment 32, which allows the operator to secure the spray wand unit 3 to a waist belt of the operator when the present invention is not operational, is adjacently connected with the spray gun 31. The spray gun 31 preferably utilizes a trigger mechanism so that the sunscreen can be dispensed by applying pressure to the trigger mechanism. However, the present invention can utilize any other type of similar mechanism which discharges sunscreen according to the preference of the operator. The wand extension 33 is an elongated member and is in fluid communication with the spray gun 31 as the wand extension 33 determines the total length of the spray wand unit 3. The power switch 7 is mainly utilized to turn-on and turn-off the pump system 6 upon the discretion of the operator. However, the power switch 7 also allows the operator to individually select each of the at least one storage tank 2 or combine all of the at least one storage tank 2 during the dispensing process. The power switch 7 is positioned on the spray gun 31 and adjacent to the wand extension 33 so that the operator can easily access the power switch 7 when necessary. The nozzle 34 dispenses the sunscreen solution in a fine mist for quick and convenient application as the nozzle 34 is concentrically connected with the wand extension 33, opposite of the spray gun 31. Optionally, the nozzle 34 can be interchanged within the present invention in order to create different spray patterns.

The connector tube 8 is a flexible hose that is in fluid communication between the outlet 12 and the spray gun 31. The connector tube 8 comprises a first fitting 81 and a second fitting 82. More specifically, the first fitting 81 and the second fitting 82 function as a quick-connect compression fitting so that the connector tube 8 can easily connect or disconnect with the outlet 12 and the spray gun 31. In reference to FIG. 1, the first fitting 81 is engaged with the outlet 12 while the second fitting 82 is engaged with the spray gun 31.

The object of the present invention is to provide a user with the means to quickly and conveniently apply sunscreen to a large number of people. The present invention eliminates the need for people to leave a venue and potentially forfeit a prime seat or a spot in line in order purchase sunscreen from a vendor. The present invention dispenses sunscreen solution in a fine mist form for people to apply evenly on exposed areas of their bodies. The present invention is convenient and efficient for the operator as the pump system 6 does not require the operator to manually discharge the sunscreen solution from the at least one storage tank 2. Since the battery 5 is simultaneously charged through the PV module 4 during usage of the present invention, the operator can continuously operate the present invention for extended periods of time.

Although the invention has been explained in relation to its preferred embodiment, it is to be understood that many other possible modifications and variations can be made without departing from the spirit and scope of the invention as hereinafter claimed.

What is claimed is:

1. A solar powered portable mister comprises:
a spray tank enclosure;
at least one storage tank;
a spray wand unit;
a photovoltaics (PV) module;
a battery;
a pump system;
the spray tank enclosure comprises an accessory compartment, an outlet, a backing, a top surface, and an angled-front surface;
the PV module being externally mounted onto the spray tank enclosure;
the at least one storage tank, the battery, and the pump system being internally positioned within the spray tank enclosure;
the PV module, the battery, and the pump system being electrically connected to each other by a power switch; and
the spray tank enclosure being in fluid communication with the spray wand unit by a connector tube.

2. The solar powered portable mister as claimed in claim 1 comprises:
the backing being adjacently positioned with the top surface;
the angled-front surface being adjacently positioned with the top surface, opposite of the backing; and
the angled-front surface being positioned with the backing at an acute angle.

3. The solar powered portable mister as claimed in claim 1 comprises:
the accessory compartment being positioned within the spray tank enclosure;
the at least one storage tank being integrated into the spray tank enclosure, adjacent to the accessory compartment;
the pump system being mounted within the accessory compartment;
the outlet traversing through the accessory compartment, adjacent to the pump system;
the battery being removably attached within the accessory compartment; and
the outlet being in fluid communication with the at least one storage tank through the pump system.

4. The solar powered portable mister as claimed in claim 3, wherein at least one storage tank is superimposed by an insulation layer.

5. The solar powered portable mister as claimed in claim 3 comprises:
the at least one storage tank comprises a tank opening and a cap;
the tank opening traversing through the spray tank enclosure; and
the cap being concentrically engaged with the tank opening.

6. The solar powered portable mister as claimed in claim 1 comprises:
a pair of adjustable shoulder straps;
the pair of adjustable shoulder straps being vertically extended along the spray tank enclosure, adjacent to the at least one storage tank; and
the pair of adjustable shoulder straps being externally connected to the backing.

7. The solar powered portable mister as claimed in claim 1 comprises:
an adjustable waist strap;
the adjustable waist strap being horizontally extended across the spray tank enclosure, adjacent to the accessory compartment; and
the adjustable waist strap being externally connected to the backing.

8. The solar powered portable mister as claimed in claim 1, wherein the PV module being adjacently positioned with the angled-front surface.

9. The solar powered portable mister as claimed in claim 1 comprises:
the spray wand unit comprises a spray gun, a belt attachment, a wand extension, and a nozzle;
the belt attachment being adjacently connected with the spray gun;
the wand extension being in fluid communication with the spray gun;
the power switch being positioned on the spray gun, adjacent to the wand extension; and
the nozzle being concentrically connected with the wand extension, opposite of the spray gun.

10. The solar powered portable mister as claimed in claim 1 comprises:
a first fitting of the connector tube being engaged with the outlet; and
a second fitting of the connector tube being engaged with the spray gun.

11. A solar powered portable mister comprises:
a spray tank enclosure;
at least one storage tank;
a spray wand unit;
a photovoltaics (PV) module;
a battery;
a pump system;
the spray tank enclosure comprises an accessory compartment, an outlet, a backing, a top surface, and an angled-front surface;
the PV module being externally mounted onto the spray tank enclosure;
the accessory compartment being positioned within the spray tank enclosure;
the at least one storage tank being integrated into the spray tank enclosure, adjacent to the accessory compartment;
the pump system being mounted within the accessory compartment;
the outlet traversing through the accessory compartment, adjacent to the pump system;
the battery being removably attached within the accessory compartment;
the outlet being in fluid communication with the at least one storage tank through the pump system;
the PV module, the battery, and the pump system being electrically connected to each other by a power switch; and
the spray tank enclosure being in fluid communication with the spray wand unit by a connector tube.

12. The solar powered portable mister as claimed in claim 11 comprises:
the backing being adjacently positioned with the top surface;
the angled-front surface being adjacently positioned with the top surface, opposite of the backing; and
the angled-front surface being positioned with the backing at an acute angle.

13. The solar powered portable mister as claimed in claim 11, wherein at least one storage tank is superimposed by an insulation layer.

14. The solar powered portable mister as claimed in claim 11 comprises:
the at least one storage tank comprises a tank opening and a cap;
the tank opening traversing through the spray tank enclosure; and
the cap being concentrically engaged with the tank opening.

15. The solar powered portable mister as claimed in claim 11 comprises:
a pair of adjustable shoulder straps;
the pair of adjustable shoulder straps being vertically extended along the spray tank enclosure, adjacent to the at least one storage tank; and
the pair of adjustable shoulder straps being externally connected to the backing.

16. The solar powered portable mister as claimed in claim 11 comprises:
an adjustable waist strap;
the adjustable waist strap being horizontally extended across the spray tank enclosure, adjacent to the accessory compartment; and
the adjustable waist strap being externally connected to the backing.

17. The solar powered portable mister as claimed in claim 11, wherein the PV module being adjacently positioned with the angled-front surface.

18. The solar powered portable mister as claimed in claim 11 comprises:
the spray wand unit comprises a spray gun, a belt attachment, a wand extension, and a nozzle;
the belt attachment being adjacently connected with the spray gun;
the wand extension being in fluid communication with the spray gun;
the power switch being positioned on the spray gun, adjacent to the wand extension; and
the nozzle being concentrically connected with the wand extension, opposite of the spray gun.

19. The solar powered portable mister as claimed in claim 11 comprises:
a first fitting of the connector tube being engaged with the outlet; and
a second fitting of the connector tube being engaged with the spray gun.
